(19) United States
(12) Patent Application Publication
(10) Pub. No.: US 2020/0273386 A1
(43) Pub. Date: Aug. 27, 2020

(54) Temporary Outdoor Banner and Sign Display Device

(71) Applicant: Mark Kreider, Murrieta, CA (US)

(72) Inventor: Mark Kreider, Murrieta, CA (US)

(21) Appl. No.: 16/799,534

(22) Filed: Feb. 24, 2020

Related U.S. Application Data
(60) Provisional application No. 62/811,330, filed on Feb. 27, 2019.

(51) Int. Cl. G09F 15/00; G09F 17/00

(52) U.S. Cl. CPC G09F 15/0018; G09F 15/0037; G09F 17/00

(57) ABSTRACT

An assembly of brackets and straps which allow quick and easy mounting of banners and signs to poles, posts, trees, walls or other structures for temporary use without affecting the surface of the supporting structure. Said device integrates a mounting bracket for a sign or banner with a means for attachment to an existing support structure. Advertising, public announcements, decorative media, and the like, can be quickly and easily mounted to the bracket which is then attached to the supporting structure without tools of any kind. Removal is similarly accomplished quickly and easily without tools. Banner media is rolled around a hollow tube for storage to prevent wrinkling and preserve for further use

### CROSS-REFERENCE TO RELATED APPLICATIONS

The present application claims the priority of U.S. Provisional Patent Application Ser. No. 62/811,330 filed Feb. 27, 2019, which application is incorporated in its entirety herein by reference.

### BACKGROUND OF THE INVENTION

The present invention is in the technical field of signs. More particularly, the present invention is in the technical field of means for attaching signs, plates, panels, or boards to a supporting structure.

Banners, signs, and other media are used indoors and outdoors to communicate information, advertise, and decorate. Permanent and long term display devices have been developed for indoor and outdoor use which use screws or metal banding and clamping mechanisms to securely attach the display device to a preexisting structure. Additionally, devices have been developed for temporary indoor use which construct their own structure to support a banner or sign. Temporary outdoor installations have been a problem for event organizers, advertisers, and others who require the ability to put up and take down banners and signs outdoors for a short duration. Large banners and signs attract more attention than small, so the ability to support large media is of great importance. The difficulty of maintaining stability of the support structure increases as the size of the media increases. Systems which use stakes driven into the ground can be difficult to install and require more installation area.

### BRIEF SUMMARY OF THE INVENTION

The present invention addresses the above and other needs by providing is an improved system and apparatus to temporarily support flexible media, henceforth referred to as banners, and rigid materials, henceforth referred to as signs, from preexisting structures without damaging the structure. It is simple, sets-up quickly and easily without tools, sturdy, and versatile. The invention improves the ability of event organizers to utilize signs to benefit indoor and outdoor events.

Identical rods and brackets are secured to the top and bottom of the display media. The brackets are then attached to a preexisting support structure with straps, buckles, hooks or other devices which can be easily applied and removed without damaging the structure.

To display banners, a rod is inserted into an open hem at the top and bottom of the banner. A chamber in the bracket securely retains the rod and hem in the bracket. The top rod and bracket suspend the banner's weight from the support structure while the bottom rod and bracket stabilize the display to the support structure. The desired tautness of the banner can be achieved by adjusting the positioning of the top and bottom brackets on the support structure. A wide variety of banner dimensions can be displayed with this invention. The current embodiment is for general use and has 6″ brackets and 24″ rods.

To display signs, the top and bottom edge of the sign is inserted into a channel of the rod. The rod and sign are then placed inside the bracket and secured to a support structure. The bottom rod and bracket bear the sign's weight from the support structure while the top rod and bracket stabilize the display to the support structure. The invention is appropriate for a wide variety of sign substrates and dimensions. The current embodiment is for 4 mm coroplast which is currently a popular material for signs. The rod's chamber has been designed with grooves that hold 4 mm coroplast firmly.

Securing the bracket to an existing structure, rather than requiring its own support structure, simplifies installation, reduces installation time, provides excellent strength and stability of the assembly, and lowers overall cost of the installation by reducing components. The means of attachment to the support structure depends greatly on the structure supporting the assembly; therefore, the bracket's design should be versatile and be able to accommodate a wide variety of installation requirements. Velcro straps or rope, a hook or a preexisting nail can be sufficient for attaching the display to a supporting structure.

The brackets have a series of mounting holes, or posts, to facilitate a wide variety of applications. The current embodiment of the invention uses an assembly of webbing, or ‘straps’, snap hooks and a side release buckle to attach brackets which are well suited to attaching the display to posts, poles, and pillars, as well as other architectural elements.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a perspective view of a display device according to the present invention supporting a banner on a pole.

FIG. 2 is a perspective view of the display device according to the present invention prior to mounting to a pole.

FIG. 3 is a perspective view of a rod according to the present invention.

FIG. 4 is a cross-sectional view of the rod according to the present invention.

FIG. 5 is a perspective view of the front of a bracket according to the present invention.

FIG. 6 is a cross-sectional view of the bracket according to the present invention.

FIG. 7 is a perspective view of rods in hems of banner inside retaining chambers of bracket according to the present invention.

FIG. 8 is a cross-sectional view of rods in hems of banner inside retaining chambers of bracket according to the present invention.

FIG. 9 is a cross-sectional view of rods in hems of banner inside retaining chambers of bracket fitting snugly inside mouth of bracket according to the present invention.

FIG. 10 is a perspective view of a rigid sign inserted into the supporting channel of the rod.

FIG. 11 is a perspective view of a rigid sign inserted into the supporting channel of the rod which has been placed into the supporting chamber of the bracket according to the present invention.

FIG. 12 is a perspective view of strap system attached to the widest mounting holes of the bracket according to the present invention.

FIG. 13 is a downward view of the top surface of the bracket according to the present invention.

FIG. 14 is a forward view of the back of the bracket according to the present invention.

FIG. 15 is a perspective view of the mounting posts and mounting holes of the bracket according to the present invention.

FIG. 16 is a perspective view of the case with a channel cut along its length according to the present invention.

FIG. 17 is an illustration of lower banner hem, rod, and bracket being inserted into case, prior to banner being rolled around tube for storage according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

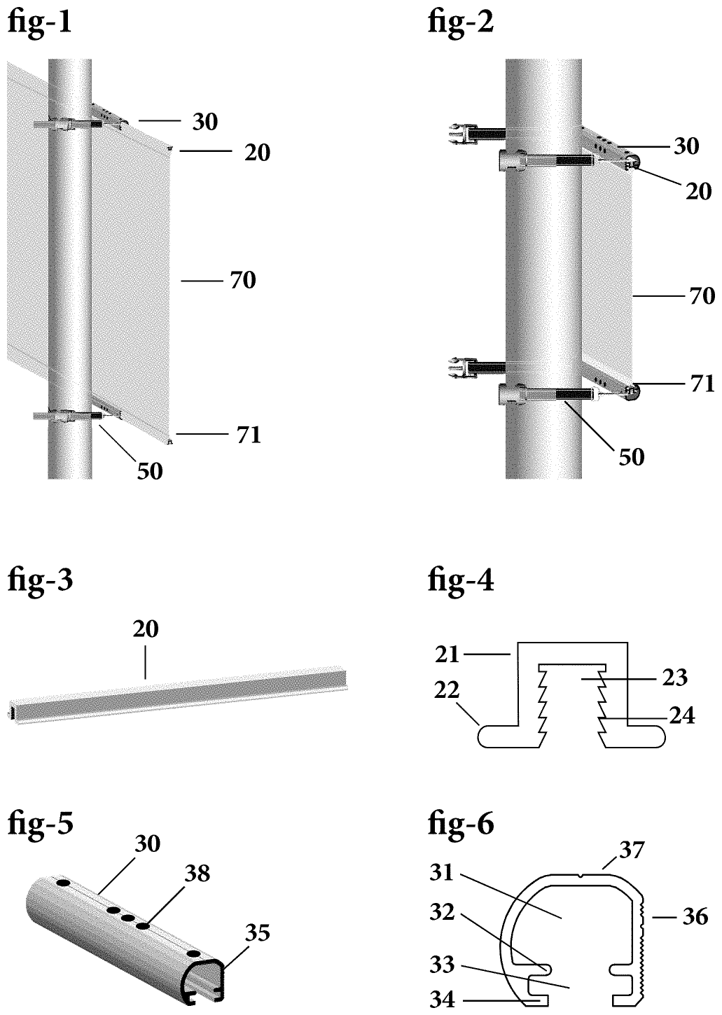

FIG. 1 shows a preferred embodiment of the present invention having two identical sets of a rod 20 and brackets 30 that attach to the top and bottom of the display media 70. The brackets 30 are secured to a support structure by straps, hooks, and buckles 50. The invention does not damage the supporting structure and can easily and quickly be set-up, taken down, and stored. These characteristics are well suited to temporary uses. Permanent and semi-permanent installation can justify more complex and expensive installation procedures; but, a one day event needing many signs will receive much benefit from this invention. Additionally, the invention improves the stability of outdoor temporary display devices because it utilizes preexisting structures of proven strength to support media.

The display media may be flexible media, such as banners, and rigid media, such as signs. The support structure may be various structure such as trees, posts, poles, pillars, walls, and other preexisting sturdy structures. The bracket may comprise a rod and bracket that securely retain the media. The bracket attaches to a stable support structure to display the media. The simplicity and speed of the installation process make the invention well suited to temporary installations. The sturdiness of the invention significantly improves temporary outdoor sign installations. In this embodiment straps, buckles and snap hooks are used to attach the device to the support structure.

Rod length and media length should be approximately the same to provide support along the entire edge of the display. The rod 20 may be aluminum, plastic, or similar material which is easily cut when necessary. The brackets 30 length is normally shorter than the media 70 width to reduce weight and cost and improve aesthetics. The width or length of the brackets 30, rod 20, and media 70 should be considered for stability and strength. Generally speaking, the brackets 30 width should be sufficient to securely fasten to a support structure and securely attach to and hold the display media 70.

FIG. 2 shows the same embodiment of the present invention; however, rods 20 and brackets 30 of identical lengths are shown to illustrate the function of design elements more clearly.

FIG. 3-4 show the rod 20 comprising a supporting channel 21, supporting channel interior 23 teeth 24, and retaining arms 22.

FIG. 5-6 show the bracket 30 comprising a retaining chamber 31, a retaining chamber mouth 32, a bracket supporting chamber 33, a supporting chamber mouth 34, a back surface 35 of the bracket 30, grooves on back surface 36, top surface of bracket 37, and mounting holes 38.

The rods 20 and brackets 30 may be made of 6063-T5 aluminum at 0.065″ thickness to be light weight and sturdy. Other materials such as carbon fiber, titanium, and alloys can be used for greater strength and/or less weight. The current embodiment of the invention is for common usage which does not justify the higher cost currently required for these more specialized materials. Aluminum is an economical means to meet the design requirements. As explained below, constructing the bracket 30 of a material with some flexibility is advantageous for holding brackets in place on the banner hem.

The invention displays flexible media and rigid media of different thicknesses. The ability to display a variety of media improves the usefulness of the invention. The current embodiment has been optimized for common applications. Currently, banner fabrics are commonly 0.010″ to 0.018″ thick and 4 mm coroplast is a common material for signs. Customizing some specifications and characteristics of the invention would be expected for displaying other materials.

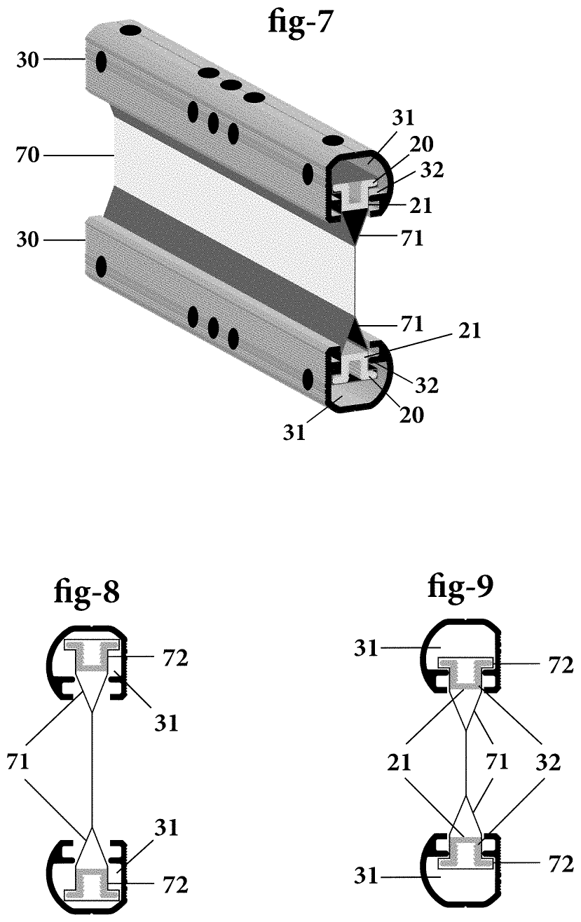

FIG. 7 shows display banner 70, and the rod 20 is inserted into open hems 71 at the top and bottom of the banner 70 with the exterior of the supporting channel 21 of rod 20 facing towards the bracket retaining chamber mouth 32. The banner hem 71 should fit loosely around the rod 20. Larger hems are acceptable and do not affect the operation of the display device. Approximately two inch hems at the banner's top and bottom are common and work well. The bracket 30 retaining chamber 31 must be large enough to accommodate the banner 70 with the rod 20 inserted therein. Extra space is provided in the bracket retaining chamber 31 to accommodate thicker media.

FIG. 8 shows the banner hem 71 and rod 20 securely positioned in the bracket retaining chamber 31 when upper and lower brackets 30 are attached to the support structure by spacing brackets on the structure far enough from each other to create pressure on the rods and brackets. However, the present invention has an additional and preferred technique.

FIG. 9 shows the banner hem 71 and rod 20 placed into the bracket retaining chamber 31, the exterior of the supporting channel of the rod 21 can be pushed into the bracket retaining chamber mouth 32 to create pressure which firmly holds the banner hem 71 and rod 20 in position. This fitting is designed for fabric 10 mil to 16 mil thick. The flexibility of the material constructing the bracket and the curvature of the bracket's shape achieve the bracket's ability to fit around banner fabrics of differing thicknesses. The rod 20 and banner hem 71 can be ‘popped-out’ of the bracket to adjust the positioning of the elements.

The weight of the banner is suspended from the upper bracket assembly. A second bracket assembly is used at the bottom of the banner to stabilized the banner to the structure.

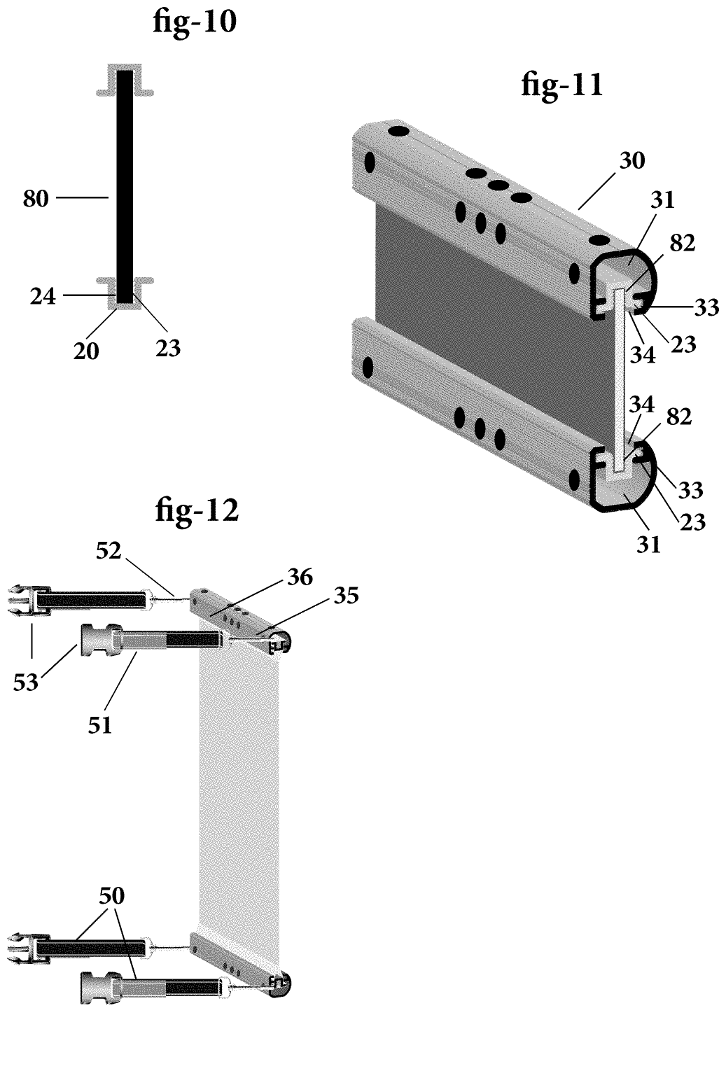

FIG. 10 shows display sign 80, the bottom edge of the sign 80 fits into the interior of the supporting channel 23 of the rod 20. Grooves 24, or teeth, in the interior of the supporting channel 23 of the rod 20, have been incorporated into the design of the interior of the supporting channel 23 to cause it to grip onto the 4 mm coroplast sign when it is inserted. While not necessary, this improves the sturdiness of the fitting of the rod and sign.

FIG. 11 shows the rod and sign 82 are inserted into the bracket 30 by inserting the retaining arms 22 of the rod 20 into the bracket supporting chamber 33 with the sign 80 extending out from the bracket supporting chamber mouth 34. The same process is followed for attaching rod and bracket to the top edge of the sign.

The weight of the sign is supported by the bottom bracket assembly. A second bracket assembly is used at the top of the sign to stabilize the sign to the structure. Thinner signs can fit loosely inside the interior of the supporting channel of the rod 20, or thicker signs can fit directly into the bracket retaining chamber 31 without using a rod 20 and still be successfully supported by the device. The preferred embodiment of the present invention is for a secure fitting of a 4 mm thick sign 80 inserted into the interior of the supporting channel 23 of the rod 20 placed into the bracket supporting chamber 33.

FIG. 12 shows the back surface of the bracket 35 can be constructed to facilitate friction against the support structure and prevent movement of the display. In this embodiment the back surface of the bracket 35 has been designed with grooves 36 and a PVC coating for this purpose. The PVC coating of the bracket 30 also minimizes damage to the support structure to leave the surface undamaged after use. Other embodiments of the bracket back could use foam, rubber, and other materials providing good friction and non-abrasive characteristics.

The display device attaches to the support structure by the most beneficial means. The present embodiment uses a strap assembly 50 comprising webbing 51, snap hooks 52, and a side release buckle 53. This means is well suited to attaching the display device to support structures such as poles, pillars and posts and adapts well to other architectural elements. Other means of attachment such as rope, hooks, Velcro, nails, might suit for attachment to other support structures better. For this reason, the bracket 30 is designed to facilitate use of other means of attachment.

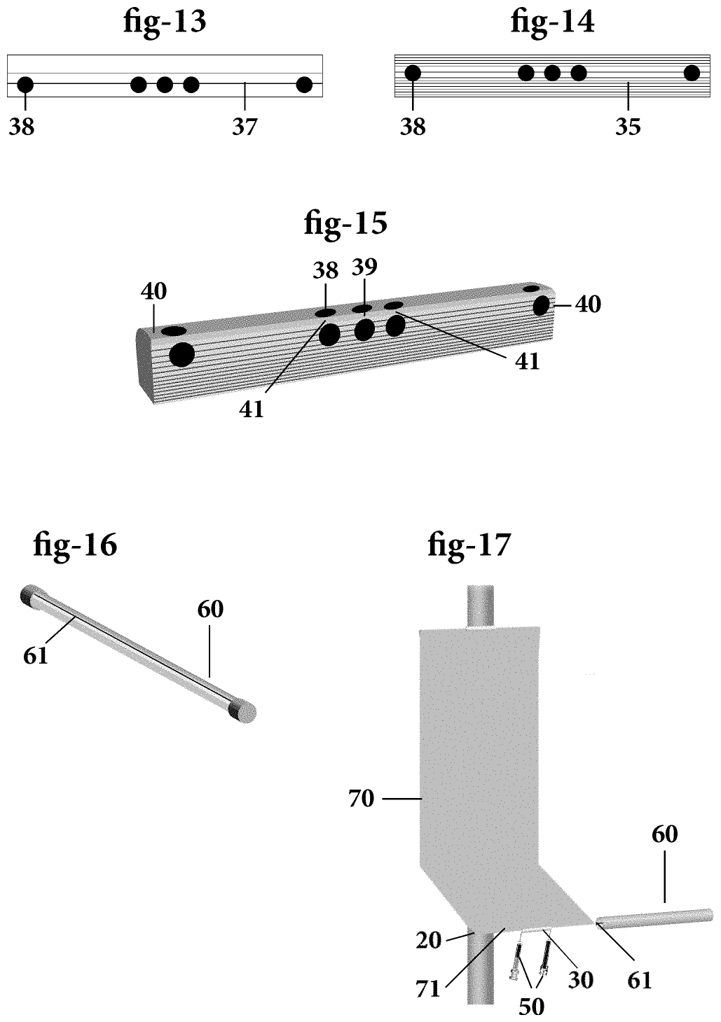

FIG. 13 illustrates the present embodiment of the invention with 5 identical mounting holes 38 through the top surface 37 of the bracket. FIG. 14 illustrates the present embodiment of the invention with 5 corresponding mounting holes 38 through the back surface 35 of the bracket.

FIG. 15 shows the bracket surface between the corresponding holes, containing the right angle created by the joining of the top and back surfaces, forms a post 39 to which snap hooks are secured. Additional posts occur at the outer edges of holes at the edge of the bracket 40. Hooks are secured around posts, i.e. inserted through corresponding holes in the top and back of the bracket.

When displaying media on a curved surface, such as a pillar, straps anchored to the bracket at a wide distance stabilize the display better. On a narrow post, straps anchored to the bracket at a narrow distance stabilize the display better.

Outer mounting posts 40 are provided for wide spacing and inner mounting posts 41 are provided for narrow spacing. A center post 39 is also provided for attachment to a single point. When used as holes rather than posts, the 10 mounting holes 38 provide ample means for making attachment to the bracket. In other embodiments, for example brackets manufactured by mold forming, straps can be attached to the bracket by posts, eyelets, or other means.

In the current embodiment straps are made of nylon webbing; however, straps can be made of polyester, Velcro, rubber or other elastic materials, rope, and other means. The length of straps should be adjustable, have a means for tightening, and provide friction against the support structure.

The financial justification for the benefits of temporary signage is greatly improved when signage can be re-used. Flexible signs, or banners are easily wrinkled and creased when not stored properly. The packaging of the current invention is a rigid case 60 made of PVC that has a channel 61 cut along its length shown in FIG. 16. End caps hold materials inside the tube prior to sale.

FIG. 17 shows the rod 20, bracket 30, and strap assembly 50 attached to the banner hem 71, the entire lower assembly can be inserted into the case 60 with the banner extended out through the channel 61. The banner 70 can then be wrapped around the case 60 to minimize wrinkling, creasing, or other damage.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

While the invention herein disclosed has been described by means of specific embodiments and applications thereof, numerous modifications and variations could be made thereto by those skilled in the art without departing from the scope of the invention set forth in the claims.

I claim:

1. A temporary outdoor banner and sign display device, comprising:
brackets, rods, and strapping devices configured to allow signs and banners to be temporarily installed on preexisting structures without affecting mounting surface;
each bracket has a grooved surface on a back to improve grip to a mounting surface;
each rod suspends banners and other flexible materials and supports signs and rigid materials;
a retaining rod fits snugly into a bracket mouth and is held in place by tension created by flexibility and circular shape of the bracket;
a grooved channel in the rod holds 4 mm coroplast securely; and
a channel cut along the length of the product case allows the bottom banner hem, bracket, and rod to slide into the tube while still attached. The banner can then be rolled around the tube to prevent wrinkling while stored for future use.
